(19) United States
(12) Patent Application Publication
(10) Pub. No.: US 2017/0196350 A1
(43) Pub. Date: Jul. 13, 2017

(54) Multifunctional Grip Electronic/ Light Emitting & Removable Sleeve Handle for a Paintbrush

(71) Applicant: Emanuele Antonio Saltalamacchia, Garfield, NJ (US)

(72) Inventor: Emanuele Antonio Saltalamacchia, Garfield, NJ (US)

(21) Appl. No.: 15/472,566

(22) Filed: Mar. 29, 2017

Related U.S. Application Data
(63) Continuation of application No. 13/473,425, filed on May 16, 2012, now Pat. No. 9,638,411.
Application No. 13/473,425 is a continuation of application No. 15/052,850, filed on Feb. 24, 2016.
Application No. 15/052,850 is a continuation-in-part of application No. 29/552,758, filed on Jan. 26, 2016.
Application No. 29/552,758 is a continuation-in-part of application No. 29/596,611, filed on Mar. 9, 2017.
(60) Provisional application No. 61/486,432, filed on May 16, 2011.

(51) Int. Cl. A46B 15/00; F21L 4/00; B25G 1/10; F21V 23/04

(52) U.S. Cl. CPC A46B 15/0036; F21V 23/0414; F21V 23/0435; F21L 4/00; B25G 1/102; A46B 2200/202; F21Y 2115/10

(57) ABSTRACT

A removable grip sleeve handle mounted onto a paintbrush includes an ergonomic encasement so that a paintbrush is to be inserted into the encasement to improve handling and control over the paintbrush. The encasement smoothly contours to the hand of a painter or user with an elongated encasement. Within the encasement are two elastic walls that can be tapered to allow the handle of a paintbrush to become lodged as it is inserted. Atop the encasement is at least one illuminating source, preferably LED's, which are used to direct light onto a painted surface. Multitude of electronic components, a wireless module standard for exchanging data over short distances, a radio scanner, a stereo system, and a USB port, can be installed into the encasement to increase productivity and provide convenience for the painter wherein the encasement functions as a grip for the paintbrush.

The current application is a continuation application of a U.S. non-provisional application Ser. No. 13/473,425 filed on May 16, 2012. The U.S. non-provisional application Ser. No. 13/473,425 claims a priority to a U.S. provisional application Ser. No. 61/486,432 filed on May 16, 2011. This application is further a continuation of U.S. non-provisional application Ser. No. 15/052,850 filed Feb. 25, 2016, a continuation in part of U.S. non-provisional design application 29/552,758 filed Jan. 26, 2016, and a continuation in part of U.S. non-provisional design application 29/596,611 filed Mar. 9, 2017.

### FIELD OF THE INVENTION

The present invention relates generally to a paintbrush as a paintbrush accessory. More particularly, the present invention's objective is to provide a paintbrush with an ergonomic sleeve handle, the sleeve handle surrounding the paintbrush handle where “the painter's grip” is normally located on the paintbrush. One power source is located within the Grip Sleeve encasement that controls multiple electronics from within one grip sleeve which may emit light upon the surface being painted.

### BACKGROUND OF THE INVENTION

Paintbrushes are typically manufactured to a set standard. These paintbrushes have a plurality of bristles, a wide paintbrush head and an elongated thin handle in which the bristles are fitted onto the paintbrush head and the paintbrush head is connected to the elongated thin handle. The majority of the weight is distributed near the wide paintbrush head. Oftentimes, this requires a painter to apply a tight grip onto the thin paintbrush handle to hold and operate it, which can become very strenuous over time. This tight grip must constantly be applied onto the thin handle to achieve the best handling over the paintbrush. For recreational painters that may have physical disabilities, particularly with the hand, painting can be near impossible with standard paintbrushes because they are neither ergonomic, nor do they easily grip into the hand of the painter. Gripping and handling these paintbrushes depends upon the painter's physical abilities—how much force can be applied from the hand onto the handle and how much strain the hand can tolerate.

Another aspect of painting that often overlooked is proper lighting onto a painting surface. The intensity of light on the surface, the angle the light is directed onto the surface and even the amount of heat that irradiates from the lighting sources are all factors leading to a painted surface that is either streak-free and or degraded with blemishes and blotches. A degraded painted surface requires multiple coats of paint to be applied until paint streaks and blotches become no longer noticeable. This is typically a result of the painted surface being poorly lit during the process of painting. In a poorly lit environment, a painted surface may appear streak-free and without blotches; however, such blotches and paint streaks may become increasingly noticeable as the intensity of light upon the surface is increased. If the light is inaccurately directed onto the surface while painting, such blotches and streaks will remain unseen to the painter. Usually floor lights or construction lights and lamps are used to light the painted surface. These can disperse significant amounts of heat into the environment, upon the painted surface and upon the painter. Further from this being an inconvenience, the immense heating can sometimes be detrimental because the wet paint dries before it has been properly distributed across the painted surface. A painter must first recognize that the heat is drying the paint too quickly and then distribute the paint faster. Consequently, if not, the paint may need to be stripped or reapplied.

Poor lighting that leads to poor paint jobs are especially apparent when painting with a paintbrush because the body of the painter can cast a shadow on a surface being painted that is much larger than the paintbrush; ultimately, this defeats the purpose of the lighting. Since most rooms are rectangular, the lighting must be repositioned as each wall is painted because of the shadows being cast from the painter and the adjacent walls. Newer homes or buildings that are to be painted sometimes do not have a power source for the construction lamps and lights to operate. This dilemma forces a painter to use natural lighting within the room or to draw power from a portable generator. Natural light cannot be directed to any location at any instant and portable generators are usually heavy and a nuisance to transport.

Paintbrushes are most commonly used when detailing along lines or contours, as well as edges between two painted surfaces because a painter can more finely control the motion of the paintbrush and the area that is being painted. It can be difficult to paint along the medium between different painted surfaces or dissimilar colors and their respective contours. Therefore, handling and control over the paintbrush is strictly important.

With advancements in technology, electronics are being installed in devices that were once considered too small to withhold them, causing the devices to become bulky. The power requirements may have required large batteries or the electronics processors that control the electronics may have been too large to fit into such devices. Nowadays, these electronics processors are capable of operating a multitude of electronics while also being minimal in size. A painter, along with many other labor oriented professions, use a variety of electronics while working such as the lighting system that must be positioned correctly, a stereo to listen to that increases productivity or cellular phones to communicate with other painters, as examples. Although these electronics have many positive functions and provide much convenience to a painter, operating these electronics while working is difficult because each device must be operated individually. Constant moving from room to room and painting surface to painting surface increases the likelihood of these electronics to need to be relocated and possible reconnected to their respective power sources. Even if the electronics are portable, all would need to be carried by the painter since a painter is moving around often. An all-inclusive single device that comprises these electronics would be convenient and would increase the speed and productivity of the painter.

The object of the present invention is to: provide lighting to a surface being painted more effectively; to provide a painter with better handling and control over the paintbrush; and to supply a painter with a single multifunctional electronic device that facilitates painting. The described problems and inconveniences with painting and all claimed objectives of the present invention are solved and achieved with a multifunctional electronic light emitting removable grip sleeve handle for a paintbrush.

### DESCRIPTION OF PRIOR ART

International Patent Publication No. 2011/054108 A10, filed Nov. 9, 2010, is a light pack for a paintbrush ferrule built with a paint can lid attachment for a paintbrush to be held in the paint can. The light pack described in this prior art is constructed as a device in which lights are positioned on a device built over the ferrule of the brush head near the bristles. The Apparatus can be configured to any standard paintbrush and the paint can lid attachment clamps to a paint can and serves as a holder for the paintbrush. The present invention is dissimilar to this prior art because it is not a sleeve handle for a paintbrush, nor is it ergonomic, nor is it a single device to accommodate the power source, the power source is wired and located away from the pack of lights, the power source is self-encased atop the thin brush handle and the power source encasement acts as a paint can lid brush holder. This prior art can be attached to any existing paintbrush; however, this requires an assembly of an assortment of attachments with exposed wires from the battery encasement to the pack of lights needing a wrap that covers the wires placed above the thin paintbrush handle of an existing paintbrush in order to hide the wires that are exploited. Furthermore, this prior art only describes a light pack for a paintbrush and it is not capable of integrating multiple electronic components that the present invention can comprise

U.S. Patent Publication No. 2006/0215391 A1, filed Sep. 28, 2006, is a lighted detail brush. This lighted brush in this prior art depicts a lighting system used with a variety handheld cleaning implements. These cleaning implements can direct light into a specified location, preferably to illuminate difficult to view areas. This prior art operates using a low power bulb or LED. The present invention is dissimilar to this prior art because the described lights are for use with cleaning equipment and do not relate to painting. Additionally, these lights are only integrated into the cleaning equipment and a grip sleeve is not provided for their handles.

U.S. Pat. No. 7,127,770 B2, issued Oct. 31, 2006, is an LED brush. The LED brush described in this prior art relates generally to cosmetic applications. The light from the LED's illuminate from a transparent handle to direct light from the end and from the sides of the transparent handle. Power is supplied to the LED's from a battery housed within the handle. The present invention is dissimilar to this prior art because the LED lights are not positioned to direct light from the translucent handle towards the bristles. This prior art relates to cosmetics and would not be compatible with a paintbrush. Also, this prior art is a single device and is not used as a grip sleeve.

U.S. Patent Publication No. 2012/0054986 A1, filed Mar. 8, 2012, is a paintbrush cover. The paintbrush cover depicted in this prior relates more particularly to a widened grip cover for a paintbrush. This prior art comprises a single opening for the entry of the paint brush handle and an inner cavity. The inner cavity can be tapered to provide an interference fit with the handle and the cover. The present invention is dissimilar to this prior art because the described cover only comprises a single-entry region for the paintbrush handle to be entered. A paintbrush must be removed from the cover by grasping the head of the paintbrush and cannot be pushed out from the bottom of the handle. This prior art is not for use with electronics and does not provide any lighting to a painted surface.

### BRIEF DESCRIPTION OF THE DRAWINGS

FIG. 1 is a front view of the present invention.

FIG. 2 is a rear view of the present invention.

FIG. 3 is a left view of the present invention.

FIG. 4 is a right view of the present invention.

FIG. 5 is a top view of the present invention.

FIG. 6 is a bottom view of the present invention.

FIG. 7 is a perspective view of the present invention.

FIG. 8 is a side view of the present invention, showing the plane 9-9 that a cross section is made.

FIG. 9 is a front cross sectional view taken along the plane 9-9.

FIG. 10 is a rear cross sectional view taken along the plane 9-9.

FIG. 11 is a front view of the present invention, showing the electrical components in dashed lines.

FIG. 12 is a perspective view of the present invention, showing a paintbrush lodged within the encasement.

FIG. 13 is a front view of the present invention, showing a paintbrush lodged within the encasement.

FIG. 14 is a perspective view of the present invention, showing an optional audible system and radiofrequency receiver.

FIG. 15 shows the preferred embodiment of the electronics processor.

FIG. 16 is a perspective view of the present invention, showing a belt clip attachment.

FIG. 17 is a schematic showing the plurality of optional electrical units of the present invention.

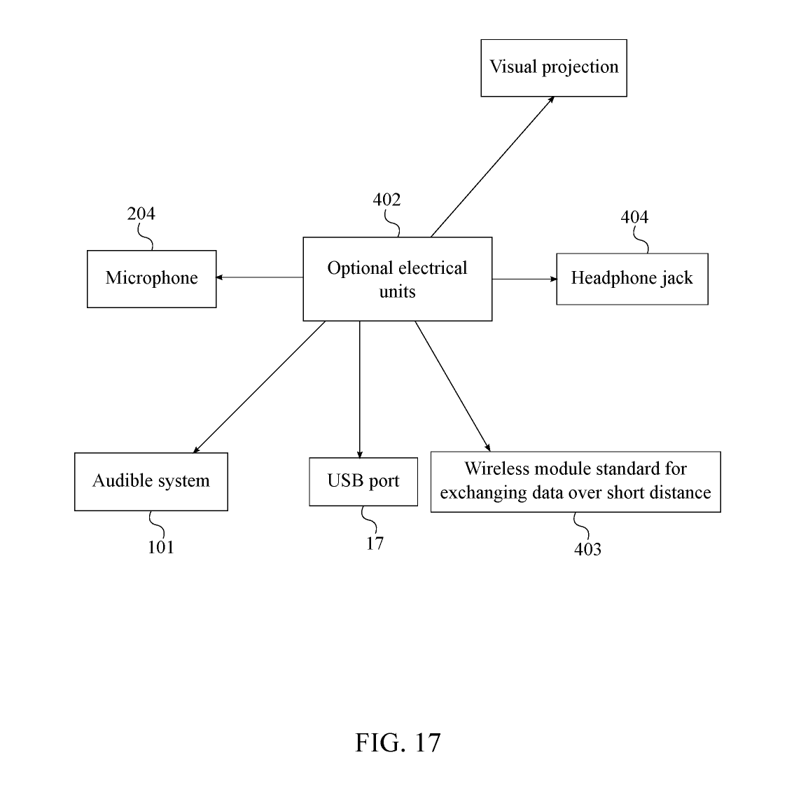

### DETAIL DESCRIPTIONS OF THE INVENTION

All illustrations of the drawings are for the purpose of describing selected versions of the present invention and are not intended to limit the scope or shape of the present invention.

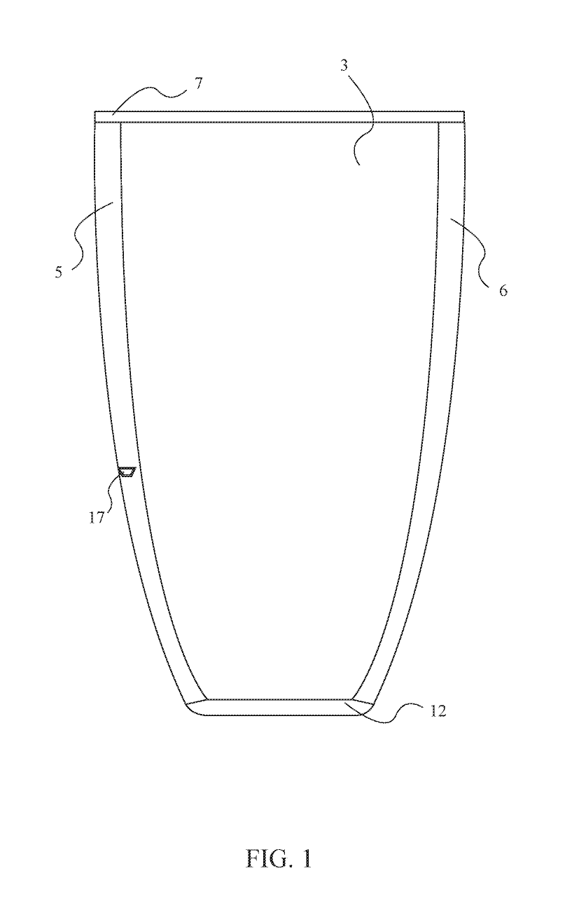

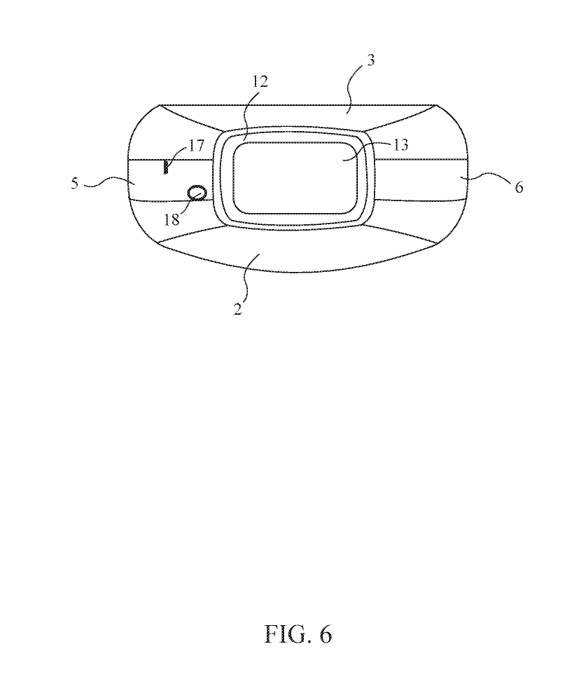

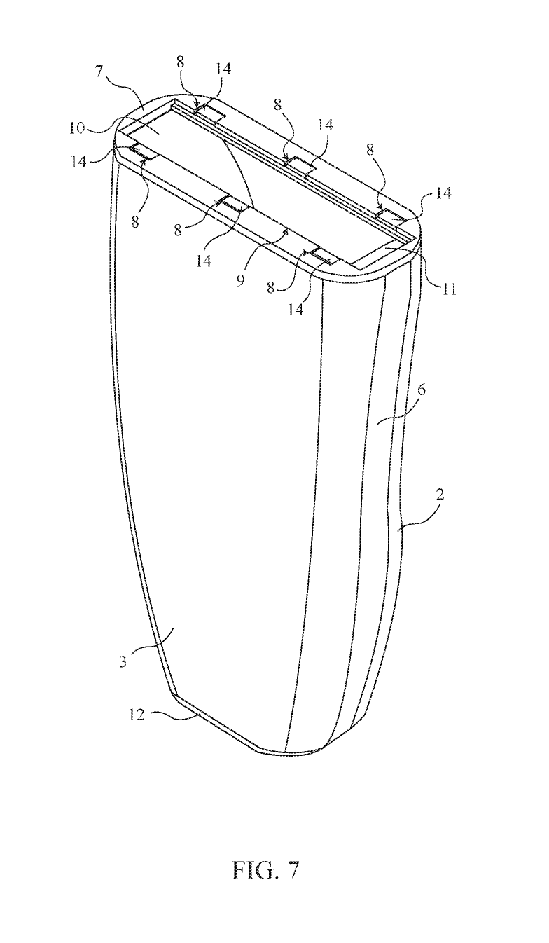

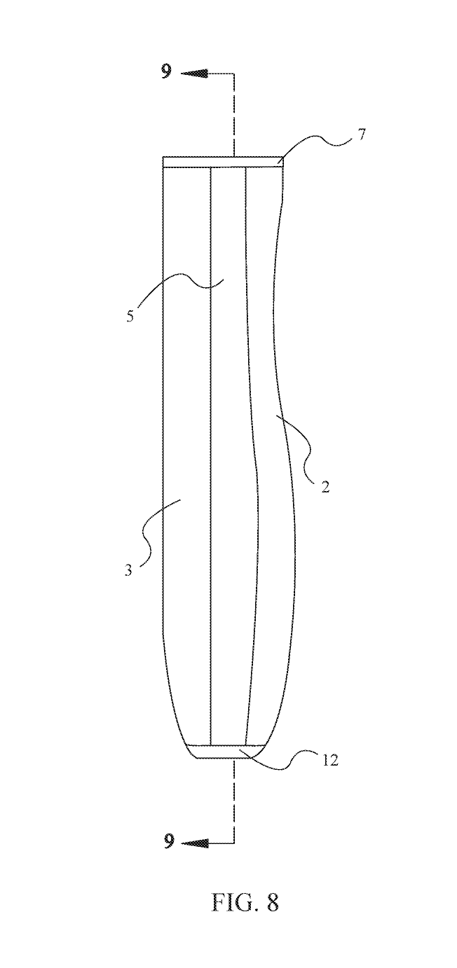

The present invention is a multifunctional electronic light emitting removable grip sleeve for a paintbrush 401, which is shown in FIG. 1-FIG. 15. The present invention provides a user, typically a painter, with a specialized holster that grips to the handle of the paintbrush 401; has the ability to direct light, enhancing vision onto a painted surface; and can operate a multitude of electronics within a single device. The present invention primarily comprises an encasement 1 and a plurality of illuminating sources 14. The encasement 1 is used to: enclose a portion of the paintbrush 401 handle to provide a painter with an ergonomic grip, reducing strain on the hand; provide the painter with increased handling over the paintbrush 401, which is especially useful when painting near the edge of conjoining surfaces or when painting difficult or intricate designs; and also encloses any electronics being operated which includes the illuminating sources 14. The illuminating sources 14 provide lighting onto a painted surface by directly projecting the light from the head of the paintbrush 401. As a result, the painted surface becomes visually enhanced, allowing the painter to more easily discern whether or not there are blemishes on the surface. Since the illuminating sources 14 move with the paintbrush 401, the painter is less likely to need to apply additional coats to the painted surface. Fewer coats would be needed because the painter would notice these blemishes while painting and be able to correct them as the current coat is being applied.

As is shown in FIG. 1-FIG. 7, the encasement 1 comprises a top wall 7, a bottom wall 12, a rear wall 2, a front wall 3, a left wall 5, a right wall 6, an open passage, a universal serial bus (USB) port 17, at least one light switch 18, a thumb groove 4, a left elastic wall 10 and a right elastic wall 11. The top wall 7 further comprises a first receiving aperture 9 and at least one recessed groove 8, and the bottom wall 12 further comprises a second receiving aperture 13. The rear wall 2 is positioned oppositely to the front wall 3 in which the left wall 5 and the right wall 6 conjoin these surfaces, wherein the left wall 5 is positioned oppositely to the right wall 6. The encasement 1 can also comprises a thumb groove 4 that is positioned atop the front wall 3. The preferred embodiment of the thumb groove 4 is an angled recessed section of the front wall 3 that is capable of having a thumb being snuggly fit within. The thumb groove 4 is essentially a smooth recessed groove in the front wall 3 that is located at a position which the average painters thumb would be, in accordance with the ergonomic shape of the rear wall 2. The rear wall 2, front wall 3, left wall 5 and the right wall 6 are enclosed by the top wall 7 and the bottom wall 12—the top wall 7 is positioned oppositely to the bottom wall 12. The top wall 7 is also concentrically positioned above the bottom wall 12, slightly resembling a cone.

As is shown in FIG. 1-FIG. 7, the preferred embodiment of the encasement 1, the rear wall is formed into a wave-shaped exterior surface, the front wall is formed into a flat exterior surface, the left wall is formed into a rounded exterior surface, and the right wall is formed into a rounded exterior surface located between an exterior surface of the top wall and the bottom wall. Resultantly, the encasement 1 is able to remove pain and relieves stress felt by fingers as contours of the encasement 1 matches the palm of the user's hand.

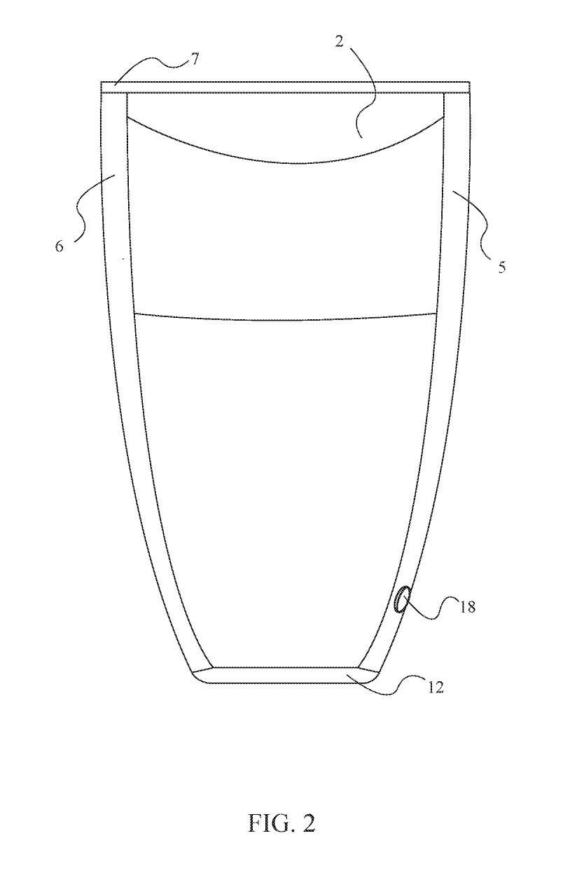

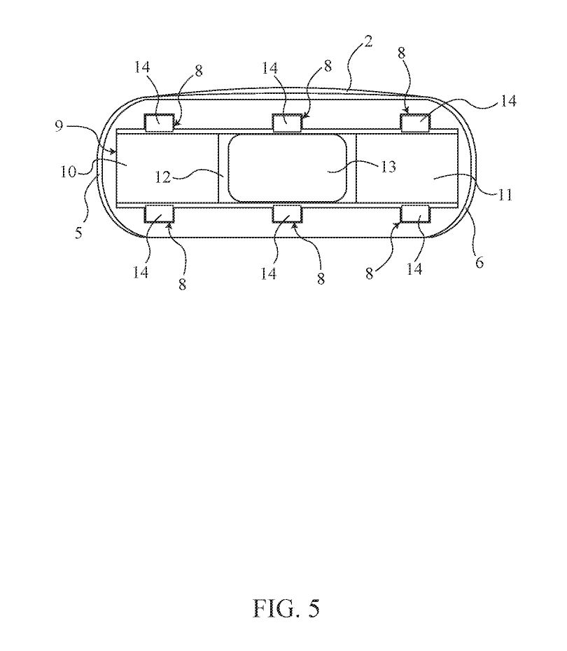

The unique shape of the encasement 1 allows the encasement 1 to be ergonomic. The ergonomic nature of the present invention decreases the amount of strain induced into a painter's hand while holding the encasement 1 with the paintbrush 401 attached. This is enabled by the contrasting wall surfaces and the gradual increasing width of these wall surfaces. The increasing width of the rear wall 2 is shown in FIG. 1 and the increasing width of the flat wall is shown in FIG. 2. As is shown in FIG. 5, the preferred shape of the rear wall 2 is such that it bows outward from the bottom wall 12, towards the top wall 7, and then bows inward as it connects to the top wall 7. Furthermore, the preferred shape of the front wall 3 should remain smooth and flat with minimal or no curvature. Positioned on the front wall 3 about midway between the top wall 7 and the bottom wall 12 should be a thumb groove 4. The duality of the shape of the rear wall 2 and the thumb groove 4 of the front wall 3 achieves the claimed ergonomic nature of the lateral ergonomic wall and the painter's ability to more easily handle the paintbrush 401 when it is attached within the encasement 1. By utilizing contrasting wall surfaces, the encasement 1 should also more easily fit within the hand of a painter. Typically, the wave-shaped exterior surface contours to the palm of a hand with the four main digits, excluding the thumb. The thumb should enwrap around either the left wall 5 or the right wall 6, depending on the dominant or painting hand of the painter, and fit within the thumb groove 4 on the front wall 3. Also, it should be noted that the USB port 17 and the light switch 18 should be positioned on the ergonomic wall in a location that does not depart from the ergonomic nature of the encasement 1. A rubber binding or similar existing or future technology can enwrap the encasement 1 to further enhance its gripping capability, wherein the rubber binding functions as an encasement wrap.

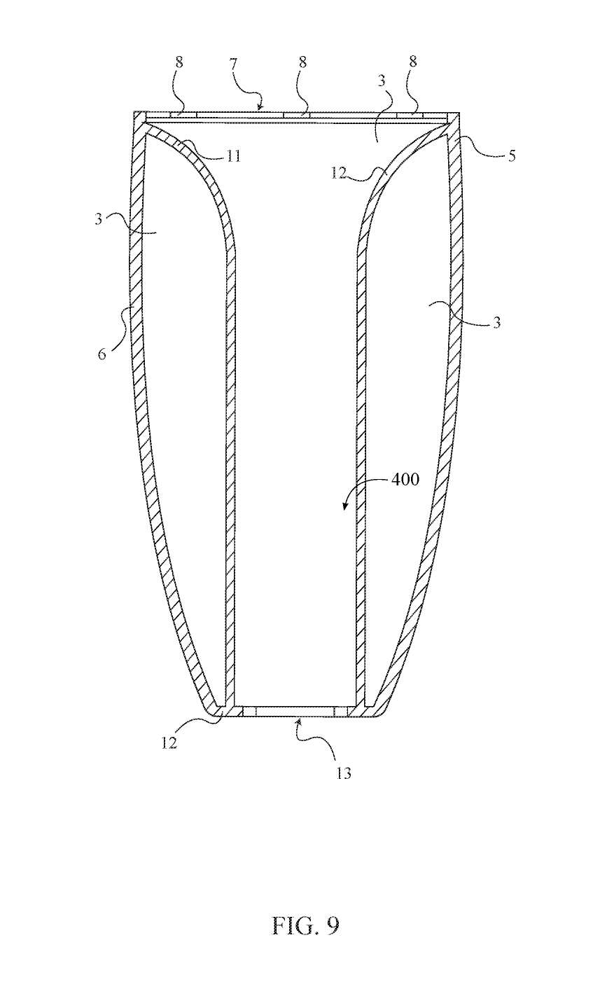

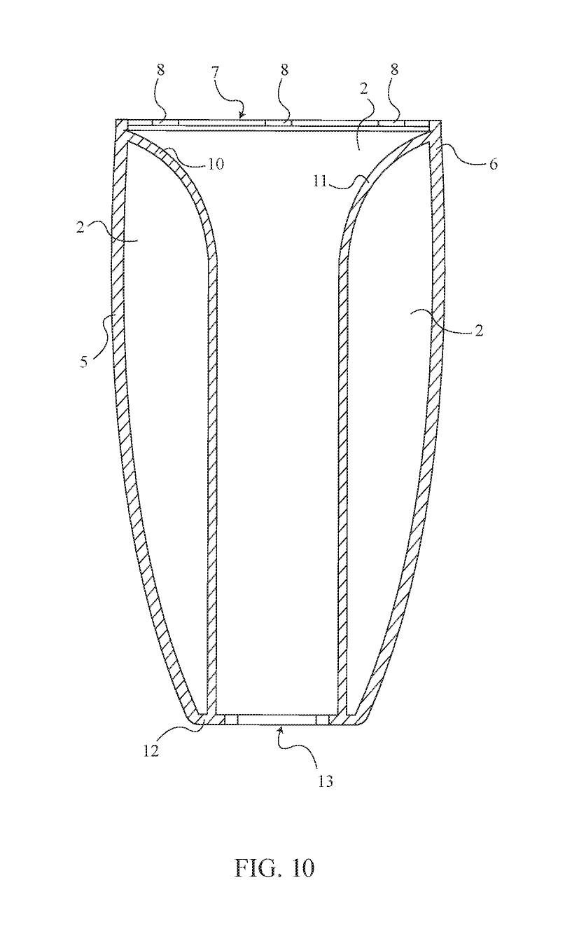

In order for the paintbrush 401 to be inserted within the encasement 1, apertures on the top wall 7 and the bottom wall 12 are provided. The first receiving aperture 9 is concentrically positioned on the top wall 7. The second receiving aperture 13 is concentrically positioned on the bottom wall 12. The top wall 7 is positioned oppositely to the bottom wall 12, wherein the ergonomic wall surfaces serve as the medium between both the top wall 7 and the bottom wall 12. An open path 400 from the first receiving aperture 9 to the second receiving aperture 13 should be made within the encasement 1, which is denoted by the open passage. Contained within the encasement 1 are the left elastic wall 10 and the right elastic wall 11. As is shown in FIG. 9 and FIG. 10, the left elastic wall 10 is connected to both the rear wall 2 and the front wall 3; concurrently, the right elastic wall 11 is connected to both the rear wall 2 and the front wall 3, but oppositely to the left elastic wall 10. In order words, the left elastic wall 10 and the right elastic wall 11 being coupled to the front wall 3 and the rear wall 2 in a substantially perpendicular manner. These elastic walls should be tapered such they follow the decreasing trend of the encasement 1, from the top wall 7 to the bottom wall 12. Therefore, the open passage should have a greater volume near the top wall 7 than near the bottom wall 12. The open passage is delineated by the first receiving aperture 9, the second receiving aperture 13, the left elastic wall 10, the right elastic wall 11, the left wall 5, the right wall 6, the front wall 3 and the rear wall 2. Additionally, the elastic wall curvature of the left elastic wall 10 and the right elastic wall 11 are substantially equivalent to the curvature of a portion for the paintbrush 401 with which the present invention is utilized.

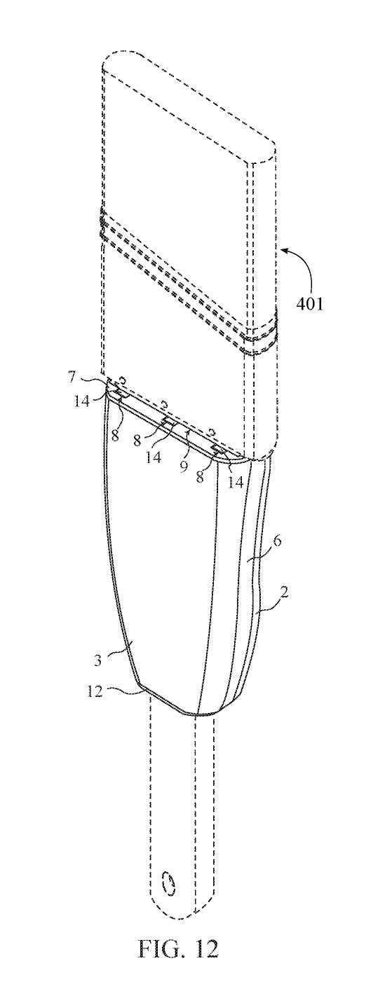

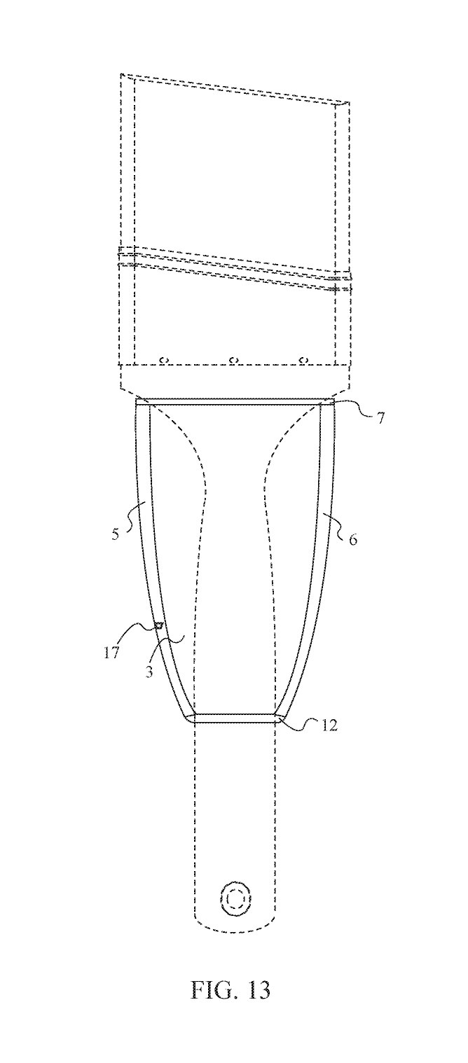

The design of the encasement 1 facilitates being used as a grip for the paintbrush 401. To be used as a grip, the bottom handle of the paintbrush 401 should be first inserted through the first receiving aperture 9. As the handle is being traversed through the first receiving aperture 9 into the encasement 1, the handle of the paintbrush 401 should make contact with both the left elastic wall 10 and the right elastic wall 11. A compressive pressure force should then be induced onto the handle from the left elastic wall 10 and the right elastic wall 11; the further the handle traverses through the encasement 1, the greater the compressive pressure force should become. This compressive pressure force onto the handle should cause the handle to become temporarily lodged within the encasement 1; FIG. 12 and FIG. 13 show the paintbrush 401 lodged within the encasement 1. Since these inner walls are elastic, they should deform and ultimately contour and embody the portion of the paintbrush 401 handle that has made contact with them. This ensures the painter that the paintbrush 401 will not be too loosely fit within the encasement 1 and that handling over the paintbrush 401 is not sacrificed. To dislodge the handle from the encasement 1, the painter should only need to pull on the head of the paintbrush 401 or push the bottom handle through the encasement 1, through the second receiving aperture 13. If the paintbrush 401 head has wet paint residue, it is usually undesirable to remove the paintbrush 401 by pulling on the head because the wet paint residue can be messy and even can be damaging. Therefore, by pushing the paintbrush 401 out of the encasement 1 from the second receiving aperture 13, the painter can safely and cleanly dislodge the paintbrush 401 without ever making contact with the paintbrush head. Also, the embodiment of the encasement 1 should only house the handle of the paintbrush 401, further preventing any paint residue from leaking within the encasement 1.

The present invention directs light onto a surface using the plurality of illuminating sources 14. Atop, the exterior surface of the top wall 7, should be the at least one recessed groove 8 which the illuminating sources 14 are to be fitted within. These recessed grooves 8 should also be perimetrically positioned around the first receiving aperture 9. Each of the plurality of illuminating sources 14 are positioned and affixed within each of the at least one recessed groove 8 as is shown in FIG. 5. The preferred embodiment of each of the illuminating sources 14 is a light emitting diode (LED). LED's require less power to operate in comparison to construction floor lamps that painters commonly use to illuminate a painted surface. These LED's also emit significantly less heat. Since the illuminating sources 14 are fitted within the recessed grooves 8, they become protected from paint drips and paint residue that may leak from the bristles of the paintbrush 401 while painting or while drawing paint out of a paint can. Since the illuminating sources 14 are positioned around the first receiving aperture 9, a painter can direct light using the illuminating sources 14 with the motion of the paintbrush 401 that is fitted within the encasement 1. The illuminating sources 14 are further protected by attaching a light cover 20 overtop the top wall 7. The light cover 20 is essentially a translucent protective surface that encloses the illuminating sources 14 within each of the recessed grooves 8. Since paint may still leak from the bristles towards the encasement 1, the light cover 20 provides supplemental protection to the illuminating sources 14 without blocking their light.

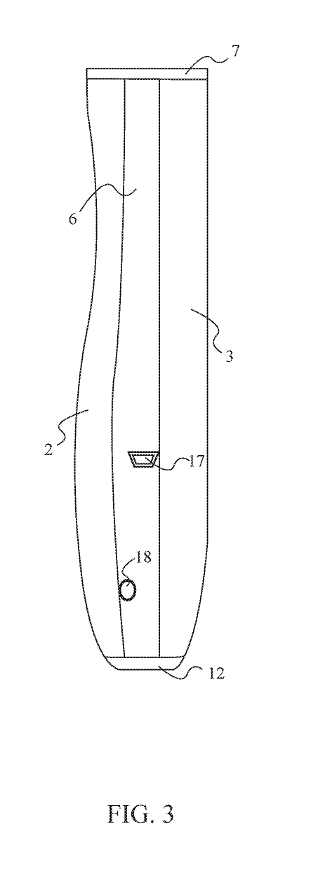

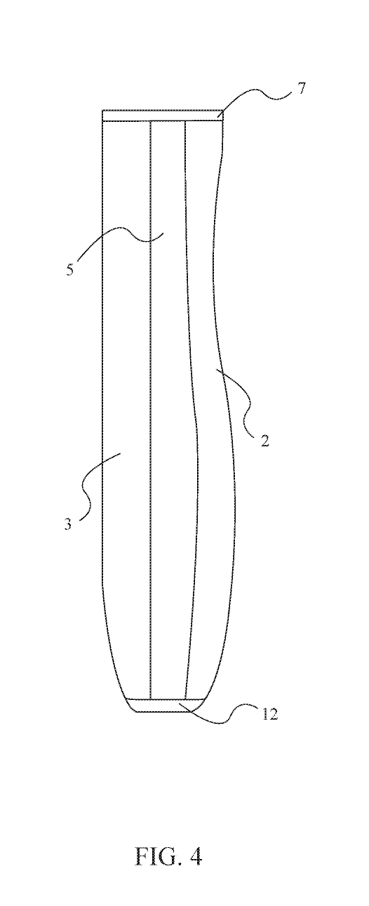

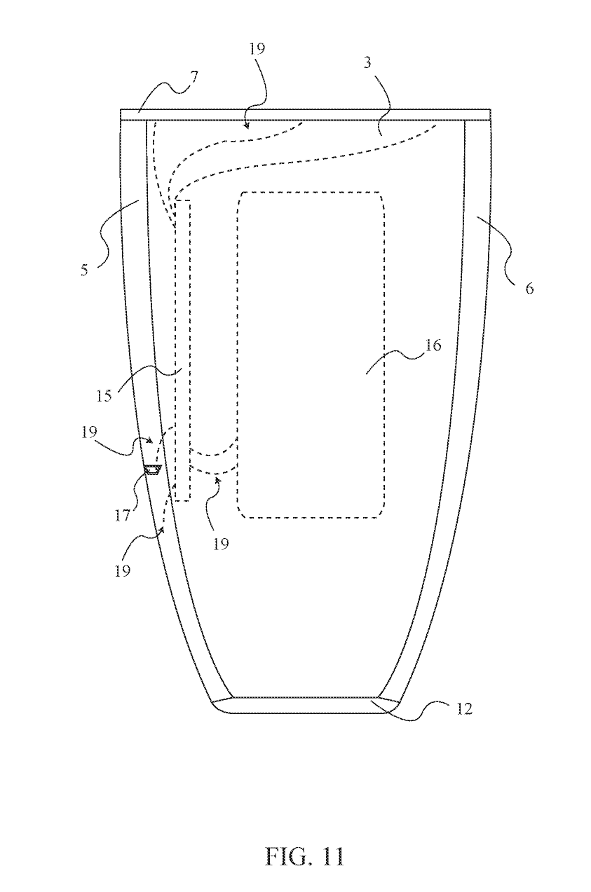

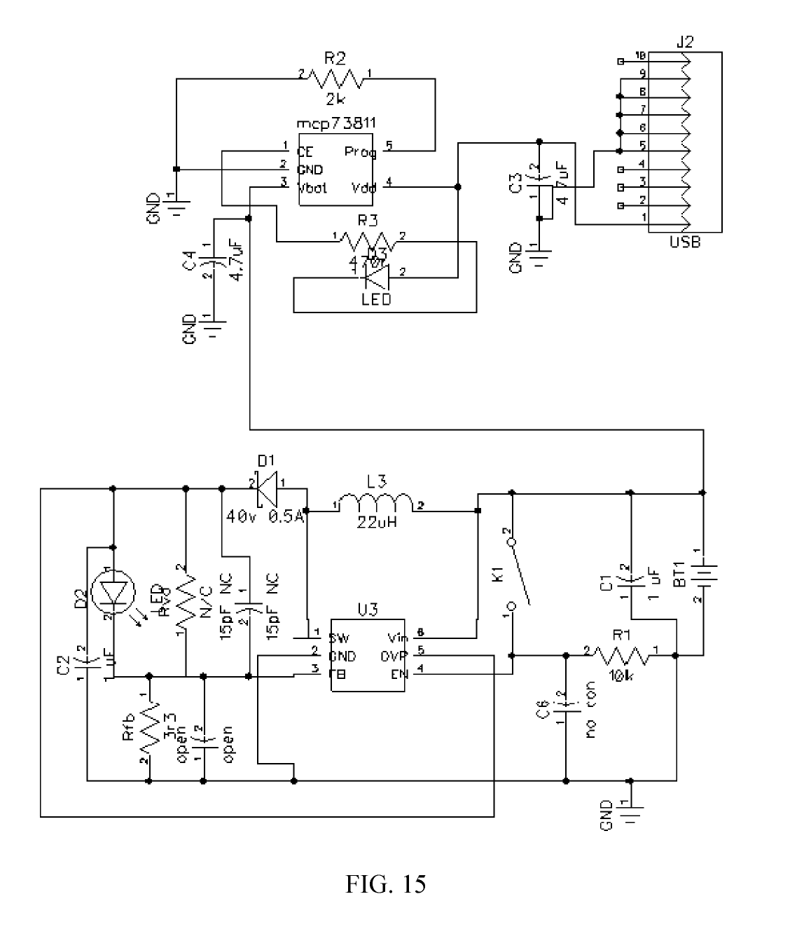

The present invention is an electrical device. To this end, the present invention comprises a power source 16, an electrical circuitry 15, and a plurality of wires 19. FIG. 11 shows the electrical components and connections within the encasement 1. All electronic components should be electrically connected to the electrical circuitry 15, preferably through the plurality of wires 19. The electrical circuitry 15 should have the ability to control any electrical and electronic installed into the present invention as the electrical circuitry 15 includes an electronics processor. The USB port 17, the light switch 18 and each of the plurality of illuminating sources 14 should be electrically connected to the electrical circuitry 15 so that the light switch 18 can control power flow to the at least one illuminating source 14. The preferred embodiment of the electrical circuitry 15 is shown in FIG. 15. The preferred embodiment of the USB port 17 is a micro USB, which is shown in FIG. 3. This shows the preferred circuitry to control LED's and to receive power through the USB port 17 or the power source 16. The electronic components should receive power from the power source 16 by electrically connecting the electrical circuitry 15 to the power source 16 through a plurality of wires 19. The electrical circuitry 15 should be able to distribute power from the power source 16 to each electrically connected component. In the preferred embodiment of the power source 16, it is a battery. If the battery is rechargeable the battery should have the ability to be recharged through the USB port 17. An adapter should be able to be connected to the USB port 17 in which this adapter should be also connected to an additional power supply. This power supply could be a wall outlet or any similar or existing technology that can receive and distribute electricity. It should be known that the USB port 17 can be used to electrically connect with a computer device or a separate electronic device. Although, the power source 16 could be replaced with another power source 14 after the power has been depleted without needing to be charged through the USB port 17. Or the entire encasement 1 could be disposable, and a new encasement 1 would be required. The preferred embodiment of the light switch 18 is an “ON/OFF” switch, which is shown in FIG. 4. This “ON/OFF” switch can be toggled to either allow power to flow or to restrict power to flow from the power source 16 to each of the illuminating sources 14. Therefore, by toggling the light switch 18 to the “ON” position, the illuminating sources 14 should begin to emit light. Another preferred embodiment of the light switch 18 is a variable switch, dimmer switch, that can permit power to be delivered in increments. This would provide the painter with the ability to control and vary the intensity of the light from the illuminating sources 14.

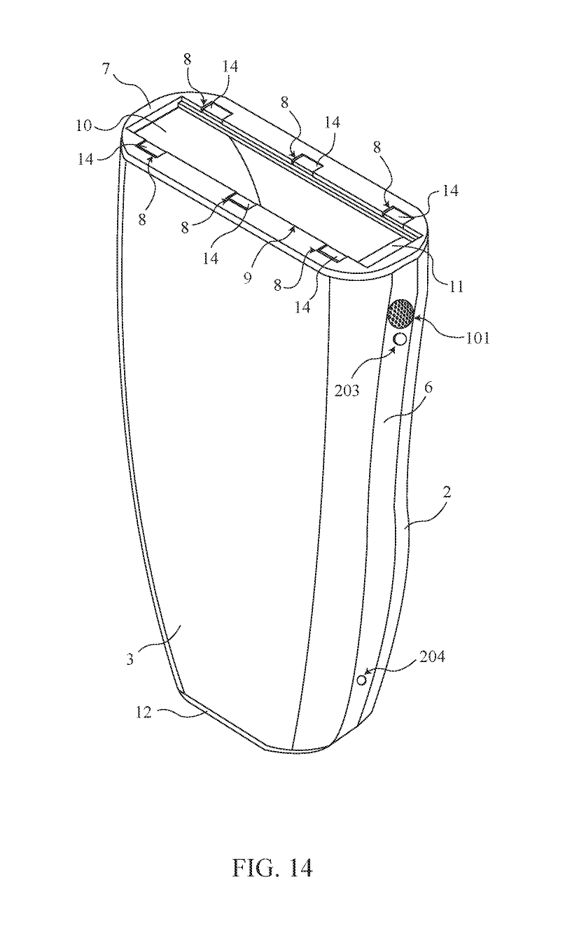

The present invention can comprise a plurality of optional electrical units 402 and should not only be limited to the aforementioned electrical components. One of the optional electrical unit 402 could be an audible system 101 that comprises a plurality of speaker wires 102 and a plurality of speakers 103, and also a radiofrequency transmitter that comprises a plurality of receiver wires 202. FIG. 14 shows the optional audible system 101. The speakers 103 of the audible system 101 should be electrically connected to the electrical circuitry 15 through the plurality of speaker wires 102 and should be integrated into the encasement 1 such that they are flush with the front wall 3. The radiofrequency receiver 201 should also be electrically connected to the electrical circuitry 15 through the plurality of receiver wires 202. The radiofrequency receiver 201 should have the ability to scan the local area for FM or AM stations. A scanning button 203 should be provided for the user to trigger the scan. Upon selecting a desired station, the audible system 101 should be able to project the sound from the selected station through the plurality of speakers 103. In effect, these additional electronic components provide a painter with a portable stereo.

Another optional embodiment of the present invention can implement a wireless module standard for exchanging data over short distances unit that is electrically connected to the electrical circuitry 15. This would allow the painter to communicate with others without having to carry around a mobile phone.

Another optional electrical unit 402 could be a microphone 204, that a user would speak into; Another optional electrical unit 402 could be a headphone jack 404. More specifically, the headphone jack 404 could also be connected to the device for the user to listen to the sound or the sound could be projected through the audible system 101. An alternative embodiment of the present invention implements a modified left elastic wall 10 and a right elastic wall 11. As opposed to a compressive pressure force being applied to the handle of the paintbrush 401 strictly because the open path 400 narrows from the top wall 7 to the bottom wall 12, a mechanical tightening system could be implemented. The mechanical tightening system would function by decreasing the volume within the open passage by causing the left elastic wall 10 and the right elastic wall 11 both to contract inwards towards each other. By contracting, the open path 400 should narrow, and a compressive force from the left elastic wall 10 and the right elastic wall 11 would lodge a portion of the paintbrush 401 handle within the encasement 1 when the respective portion is inserted into the open path 400.

The present invention is multifunctional and can be used in tandem with other painting accessories. It is not uncommon for a painter to strap a flashlight to a helmet, hardhat, head strap or similar head devices so that the lighting is steady and only moves with the motion of the painter's body, not their arm or hand. The present invention could be used to strap onto these head devices. Additional components or connections could simply be installed onto the present invention or adhesives such as Velcro could be simply adhered to the encasement 1 and to the head device to provide this capability without departing from the scope of the present invention.

Another alternative embodiment of the present invention could be an electronic grip sleeve that uses an interchangeable paintbrush head that does not need an entire paintbrush. The paintbrush head would be attached into the first receiving aperture 9 and the encasement 1 would operate as the handle of the paintbrush. Though, the paintbrush head could be fixed to the encasement 1 making the present invention an electronic paintbrush. This electronic paintbrush would not require any assembly with a paintbrush because the brush head would be part of the invention and the handle could simply be an elongated encasement 1.

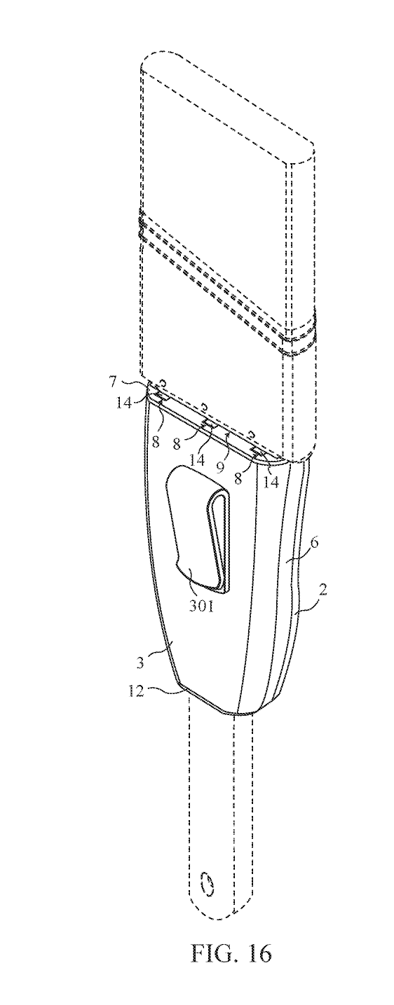

Another alternative embodiment of the present invention comprises an attachment clip 301, which is shown in FIG. 16. This attachment clip 301 is essentially a clothing clip or belt clip for the encasement 1 to be attached to. The addition of this component allows a painter to easily transport the present invention. If the painter is needs to use multiple paintbrushes, whether for painting dissimilar colored surfaces as an example, the paint can then simply insert the paintbrush 401 into the encasement 1 and then clip the encasement 1 with the paintbrush 401 onto a belt or clothing apparel with the attachment clip 301. Therefore, the painter would have the capability to carry multiple paintbrushes at a time.

Although the invention has been explained in relation to its preferred embodiment and exemplary embodiment, it is to be understood that many other possible modifications and variations can be made without departing from the spirit and scope of the invention as hereinafter claimed.

What is claimed is:

1. An apparatus comprises:
a removable grip sleeve handle mounted onto a paintbrush handle.

2. The apparatus as claimed in claim 1 comprises:
the removable grip sleeve handle being an electronic grip sleeve handle.

3. The apparatus as claimed in claim 2 comprises:
the removable electronic grip sleeve handle being a multifunctional electronic grip sleeve handle.

4. The multifunctional electronic grip sleeve handle as claimed in claim 3, being a multifunctional electronic paintbrush, the multifunctional electronic paintbrush comprising; a removable grip sleeve handle configured to receive a paintbrush.

5. The apparatus as claimed in claim 1 comprises:
an elongated ergonomic encasement;
the elongated ergonomic encasement comprises a top wall, a bottom wall, a left wall, a right wall, a front wall, a rear wall, a top inner wall, a bottom inner wall, a left inner wall, and a right inner wall; and
the ergonomic encasement having a first receiving aperture through at least one wall and a second receiving aperture through the opposite of the at least one other wall, the ergonomic encasement including at least one open path extending from the first receiving aperture to the second receiving aperture and at least one open path being configured to receive the paintbrush.

6. The apparatus as claimed in claim 5 comprises, wherein the elongated ergonomic encasement being a palm contouring elongated encasement.

7. The apparatus as claimed in claim 2 further comprising;
at least one illuminating source positioned in or on an exterior surface of at least one wall;
at least one power source located within the ergonomic encasement, the at least one power source being configured to power the electrical components via an electrical circuitry; and
at least one switch coupled to the at least one power source and the illuminating source via the electrical circuitry, the at least one switch controlling power flow to the illuminating source, wherein the switch or electrical components is either performed manually or voice activated via microphone.

8. The apparatus as claimed in claim 7 further comprising;
at least one recessed groove recessed in or on the exterior surface of the wall, each of the at least one recessed grooves containing the illuminating source.

9. The apparatus as claimed in claim 8 further comprising each of the at least one recessed grooves being recessed in or on the exterior wall and positioned around the first receiving aperture.

10. The apparatus as claimed in claim 8 further comprising:
at least one groove cover located above or within one of the at least one recessed grooves, the at least one groove cover enclosing at least one illuminating source in the at least one recessed groove.

11. The apparatus as claimed in claim 7 further comprising:
a plurality of optional electrical units;
the plurality of optional electrical units is electrically connected to the electrical circuitry; and
the plurality of optional electrical units comprises components selected from the group consisting of an audible system, a headphone port, a wireless module standard for exchanging data over short distance, a USB port, a microphone, and a visual projection.

12. The apparatus as claimed in claim 2 further comprising:
an attachment clip connection; and
the attachment clip connection engages to the belt or waist of the user to the removable grip sleeve handle or the electronic grip sleeve handle.

13. The apparatus as claimed in claim 7 further comprising the at least one switch being one of the group consisting of an on/off switch, a dimmer switch, and a voice activated switch.

14. The apparatus as claimed in claim 7 further comprising the electrical circuitry including an electronics processor or a microcontroller.

15. The apparatus as claimed in claim 7 further comprising the illuminating source being an LED or another illuminating source.

16. The apparatus as claimed in claim 2 further comprising:
an encasement wrap.

17. The apparatus as claimed in claim 16 further comprising the encasement wrap being externally bound around the encasement with a soft rubber binding.

18. The apparatus as claimed in claim 5 further comprising:
a top elastic wall and a bottom elastic wall, the top elastic wall being located between the front wall and the rear wall, the bottom elastic wall being located between the front wall and the rear wall and or opposite of the inner wall.

19. The apparatus as claimed in claim 18 further comprising the left elastic wall and the right elastic wall being coupled to the front wall and the rear wall in a substantially perpendicular manner.

20. The apparatus as claimed in claim 19 further comprising the left elastic wall and the right elastic wall being formed of a material able to exert a compressive stress on a portion of the paintbrush when the portion is inserted into the open path.

21. The apparatus as claimed in claim 18 further comprising the elastic wall curvature of the left elastic wall, the right elastic wall, the top wall, and the bottom wall being substantially equivalent to the paintbrush curvature of a portion of the paintbrush with which the sleeve is utilized.

22. The apparatus as claimed in claim 7 further comprising the power source being at least one of the group consisting of a battery and a rechargeable power source, or a removable/attachable power source.

23. The apparatus as claimed in claim 5 further comprising:
a mechanical tightening system able to exert a compressive force on a portion of the paintbrush when the portion is inserted into the open path.

24. The apparatus as claimed in claim 5 further comprising:
the front wall being positioned opposite the rear wall; and
the rear wall being coupled to the front wall by the left wall and the right wall, the left wall positioned opposite the right wall.

25. The apparatus as claimed in claim 5, wherein the ergonomic encasement being formed overall into a U-shaped encasement.

26. The apparatus as claimed in claim 25, wherein the ergonomic encasement being formed into an elongated, U-shaped encasement; elongated from the at least one of the exterior walls.

27. The apparatus as claimed in claim 5, wherein at least one wall having a wave-shaped exterior surface and at least one wall having a flat exterior surface, and at least one rounded exterior surface located on the exterior surface of the walls.

28. The apparatus as claimed in claim 5, wherein the encasement operates as the handle of the paintbrush.

29. The apparatus as claimed in claim 5, wherein the encasement and the elongated encasement smoothly contours to the hand of the painter or user.

30. The apparatus as claimed in claim 5, wherein the wave shape exterior surface contours to the hand.

31. The apparatus as claimed in claim 5, wherein at least one recessed groove is recessed on the exterior surface of the grip sleeve for a thumb.

32. A method for illuminating an area around a paintbrush comprising:
slidably attaching a removable encasement over a portion of the paintbrush; and
the removable encasement comprised of:
an ergonomic encasement including an open path extending from the first receiving aperture to the second receiving aperture, the open path being configured to removably attach to a portion of the paintbrush;
at least one illuminating source positioned in or on an exterior surface of the exterior walls;
at least one power source located within the encasement, the at least one power source being configured to power the illuminating source via an electrical circuitry;
at least one switch coupled to the at least one power source and the illuminating source via the electrical circuitry, the at least one switch controlling power flow to the illuminating source.

33. The method as claimed in claim 32, wherein the illuminating source directs light onto a surface.

34. The method as claimed in claim 33, wherein the surface is a surface being painted.
